(19) United States
(12) Patent Application Publication
(10) Pub. No.: US 2024/0288579 A1
(43) Pub. Date: Aug. 29, 2024

(54) METHOD AND DEVICE FOR PERFORMING ULTRASONIC IMAGING WITH ROW-COLUMN ADDRESSING

(71) Applicant: MODULEUS, TOURS (FR)

(72) Inventors: Audren BOULME, TOURS (FR); Pascal CHATAIN, TOURS (FR); Stéphane BREBION, TOURS (FR)

(21) Appl. No.: 18/572,192

(22) PCT Filed: Jun. 9, 2022
(86) PCT No.: PCT/EP2022/065642

§ 371 Date: Dec. 20, 2023

(30) Foreign Application Priority Data
Jun. 25, 2021 (FR) FR2106871

(51) Int. Cl. G01S 15/89; G01S 7/52

(52) U.S. Cl. CPC G01S 15/8925; G01S 7/52022; G01S 7/52085; G01S 15/8993

(57) ABSTRACT

A method of acquiring an image of a body by an array of ultrasonic transducers connected in rows and columns. The method includes: performing N successive shots of the same ultrasonic wave in the direction of the body, where N is an integer greater than or equal to 2; and after each shot, implementing a reception phase of a return ultrasonic wave reflected by the body, where, during each of the reception phases, an electrical variable quantity representative of the received wave is read on each row electrode of the device, and where, between any two of the N reception phases, the sign of the individual contribution of at least one elementary ultrasonic transducer of the array is modified.

### RELATED APPLICATIONS

The present application is based on, and claims priority to French patent application FR2106871 filed on Jun. 25, 2021 and entitled “Procédé et dispositif d'imagerie ultrasonore à adressage ligne-colonne”, which is hereby incorporated by reference to the maximum extent allowable by law.

### FIELD

The present description relates to the field of ultrasonic imaging, and more particularly to a device comprising an array of row-column addressed ultrasonic transducers, and to a method of acquiring an image of a body by means of such a device.

### BACKGROUND

An ultrasound imaging device typically comprises a plurality of ultrasound transducers, and electronic control circuitry connected to the transducers. In operation, all the transducers face a body whose image is to be acquired. The electronic control circuit is configured to apply electrical excitation signals to the transducers, so as to cause the transducers to emit ultrasonic waves in the direction of the body or object to be analyzed. The ultrasonic waves emitted by the transducers are reflected by the body to be analyzed (by its internal and/or surface structure), then return to the transducers, which convert them back into electrical signals. These electrical response signals are read by the control electronics, and can be stored and analyzed to deduce information about the body under study.

Ultrasound transducers can be arranged in a strip in the case of a two-dimensional image acquisition device, or in an array in the case of a three-dimensional image acquisition device. In the case of a two-dimensional image acquisition device, the image acquired is representative of a section of the body studied in a plane defined by the axis of alignment of the transducers of the bar on the one hand, and by the direction of emission of the transducers on the other. In the case of a three-dimensional image acquisition device, the image acquired is representative of a volume defined by the two directions of alignment of the array of transducers and by the direction of emission of the transducers.

Three-dimensional image acquisition devices can be divided into “fully populated” devices, in which each transducer of the array is individually addressable, and “Row-Column Addressing” (RCA) devices, in which the transducers of the array are addressable by row and column.

Fully populated devices offer greater flexibility in the shaping of ultrasonic beams on transmit and receive. However, the control electronics of the array are complex, with the number of transmit/receive channels required equal to M*N in the case of an M rows by N columns array. In addition, the signal-to-noise ratio is generally relatively low, as each transducer has a small surface area exposed to the ultrasonic waves.

RCA-type devices use different ultrasonic beam shaping algorithms. Beam shaping options may be reduced compared to fully populated devices. However, the control electronics of the array are considerably simplified, as the number of transmit/receive channels required is reduced to M+N in the case of an M-row by N-column array. In addition, the signal-to-noise ratio is improved by interconnecting the transducers in rows or columns during the transmit and receive phases.

The focus here is on devices and processes for acquiring three-dimensional images using row-column addressing (RCA).

It would be desirable to improve at least some aspects of devices and processes for acquiring three-dimensional ultrasound images with row-column addressing.

### SUMMARY OF THE INVENTION

To this end, one embodiment provides a method of acquiring an image of a body by means of a row-column addressed matrix ultrasound imaging device, the device comprising an array of elementary ultrasound transducers connected in rows and columns by row electrodes and column electrodes respectively, the method comprising:
performing N successive shots of the same ultrasonic wave towards said body, where N is an integer greater than or equal to 2; and
after each shot, implementing a phase of reception, by means of said device, of a return ultrasonic wave reflected by said body,
wherein, during each reception phase, a variable electrical quantity representative of the received wave is read at each row electrode of the device,
   and in which, between any two of the N reception phases, the sign of the individual contribution of at least one elementary ultrasonic transducer of the array is modified.

According to one embodiment, during each of the N reception phases, each column electrode of the array is maintained at a DC bias voltage, and, between any two of the N reception phases, the sign of the DC bias voltage applied to at least one of the device's column electrodes is modified.

In one embodiment, the signs of the polarization voltages applied respectively to the device's column electrodes during the N reception phases are coded by the vectors of an orthogonal matrix, for example a Hadamard matrix.

According to one embodiment, N successive shots are performed by means of said row-column-addressed matrix ultrasonic imaging device, and, during each of the N shots, each column electrode of the array is held at a DC bias voltage, and an AC excitation voltage superimposed on the DC bias voltage is applied to said column electrode, and, during each shot, the signs of the DC bias voltages respectively applied to the array column electrodes are the same as the signs of the DC bias voltages respectively applied to the column electrodes during the subsequent reception phase.

In one embodiment, between any two of the N reception phases, the electrical connection of at least one elementary transducer between the row and column electrodes is reversed by means of a switch system, so as to modify the sign of the individual contribution of said at least one elementary ultrasonic transducer in the array.

In one embodiment, the ultrasonic transducers are CMUT or PMUT transducers.

In one embodiment, the array comprises N rows and N columns of elementary ultrasonic transducers.

According to one embodiment, the process comprises a step in which an electronic processing device calculates an individual contribution from each of the elementary transducers in the array by means of linear combinations of the variable electrical quantities read from the device's row electrodes during the N reception phases.

In one embodiment, the variable electrical quantity read on each row electrode of the device is a voltage value.

A further embodiment provides a row-column addressed matrix ultrasonic imaging device, the device comprising an array of elementary ultrasonic transducers connected in rows and columns by row electrodes and column electrodes respectively, and a control circuit configured to implement a process as defined above.

In one embodiment, the ultrasonic transducers are CMUT or PMUT transducers.

### BRIEF DESCRIPTION OF THE DRAWINGS

These and other features and advantages will be set out in detail in the following non-limiting description of particular embodiments in relation to the accompanying figures, which include:

FIG. 1 is a top view schematically and partially illustrating an example of a row-column-addressed ultrasonic matrix imaging device;

FIG. 2 comprises a sectional view along a plane A-A of FIG. 1, and a sectional view along a plane B-B of FIG. 1, illustrating in greater detail an example of the device shown in FIG. 1;

FIG. 3 is an equivalent electrical diagram of a 2×2 row-column-addressed ultrasonic matrix imaging device operating in reception mode;

FIG. 4 is an equivalent electrical diagram of a row-column-addressed matrix imaging device of dimensions N×N operating in reception mode;

FIG. 5 illustrates schematically, in the form of diagrams, the behavior of an example of an ultrasonic transducer in emission;

FIG. 6 illustrates schematically, in the form of diagrams, the behavior of an example of an ultrasonic transducer in reception;

FIG. 7 schematically illustrates a TX transmission step and an RX reception step of a method for acquiring an image of a body by means of a row-column-addressed matrix ultrasound imaging device of dimensions N×N;

FIG. 8 schematically illustrates the steps in a process for acquiring an image of a body using a 2×2 row-column-addressed matrix ultrasound imaging device; and

FIG. 9 schematically illustrates the steps in a process for acquiring an image of a body using a 4×4 row-column-addressed matrix ultrasound imaging device.

### DETAILED DESCRIPTION

The same elements have been designated by the same references in the various figures. In particular, structural and/or functional elements common to the various embodiments may have the same references and may have identical structural, dimensional and material properties.

For the sake of clarity, only those steps and elements that are useful for understanding the described embodiments have been represented and are detailed. In particular, the various applications that the imaging devices and processes described may have not been detailed, as the embodiments described are compatible with the usual applications of ultrasound imaging solutions. In particular, the properties (frequencies, shapes, amplitudes, etc.) of the electrical excitation signals applied to the ultrasonic transducers have not been detailed, the embodiments described being compatible with the excitation signals usually used in ultrasonic imaging systems, which can be chosen according to the application under consideration and in particular the nature of the body to be analyzed and the type of information sought to be acquired. Similarly, the various processes applied to the electrical signals supplied by the ultrasound transducers to extract useful information about the body to be analyzed have not been detailed, as the embodiments described are compatible with the processes usually implemented in ultrasound imaging systems. Furthermore, the circuits for driving the ultrasonic transducers of the imaging devices described have not been detailed, the modes of embodiment being compatible with all or most known circuits for driving ultrasonic transducers of row-column addressed matrix ultrasonic imaging devices, or the realization of such circuits being within the reach of the person skilled in the art on reading the present description. Furthermore, the realization of the ultrasonic transducers of the imaging devices described has not been detailed, the embodiments described being compatible with all or most known ultrasonic transducer structures.

Unless otherwise specified, when reference is made to two elements being connected to each other, this means directly connected without any intermediate elements other than conductors, and when reference is made to two elements being “coupled” to each other, this means that these two elements may be connected or may be connected via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the figures.

Unless otherwise specified, the expressions “about”, “approximately”, “substantially”, and “of the order of” mean to within 10%, preferably to within 5%.

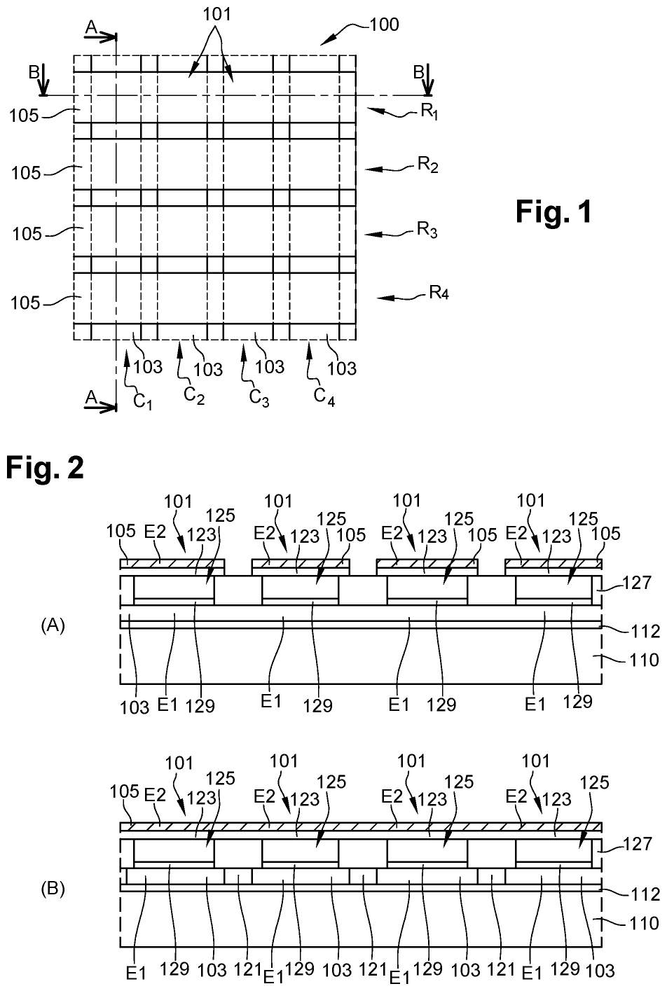

FIG. 1 is a top view schematically and partially illustrating an example of a row-column-addressed matrix ultrasound imaging device 100.

FIG. 2 shows two cross-sectional views (A) and (B) of the device 100 shown in FIG. 1, along planes A-A and B-B of FIG. 1 respectively.

Device 100 comprises a plurality of ultrasonic transducers 101 arranged in an array along M rows Rᵢ and N columns Cⱼ, where M and N are integers greater than or equal to 2, i is an integer ranging from 1 to M, and j is an integer ranging from 1 to N.

In FIG. 1, four rows R₁, R₂, R₃, R₄ and four columns C₁, C₂, C₃, C₄ have been shown. In practice, the number M of rows and N of columns in device 100 can of course be different from 4.

Each transducer 101 of device 100 comprises a lower electrode E1 and an upper electrode E2 (FIGS. 2A and 2B). When a suitable excitation voltage is applied between its electrodes E1 and E2, the transducer emits an ultrasonic acoustic wave. When the transducer receives an ultrasonic acoustic wave in a certain frequency range, it supplies a voltage representative of the received wave between its electrodes E1 and E2.

In this example, transducers 101 are capacitive membrane transducers, also known as CMUT transducers (Capacitive Micromachined Ultrasonic Transducer).

In each column Cⱼ of the transducer array, the transducers 101 in the column have their respective bottom electrodes E1 connected to each other. The bottom electrodes E1 of transducers 101 in separate columns, on the other hand, are not connected to each other. Furthermore, in each row Rᵢ of the transducer array, the transducers 101 in the row have their respective top electrodes E2 connected to each other. However, the top electrodes E2 of transducers 101 in separate rows are not connected to each other.

In each column Cⱼ of device 100, the lower electrodes of the column's transducers 101 form a continuous E1 conductive or semiconductive strip 103, extending along substantially the entire length of the column. Alternatively, each strip 103 of electrodes E1 comprises a vertical stack of a semiconductor strip and a conductor strip, each extending along substantially the entire length of the column. In addition, in each row Rᵢ of device 100, the top electrodes E2 of the transducers 101 in the row form a continuous conductive or semiconductive strip 105, extending along substantially the entire length of the row. Alternatively, each strip 105 of electrodes E2 comprises a vertical stack of a semiconductor strip and a conductor strip, each extending along substantially the entire length of the row. For the sake of simplicity, only the lower 103 and upper 105 electrode strips are shown in FIG. 1.

In the example shown, the strips 103 forming the column electrodes are made of a doped semiconductor material, such as doped silicon. In addition, in this example, the strips 105 forming the row electrodes are made of metal. As an example, when viewed from above, the lower strips 103 are parallel to each other, and the upper strips 105 are parallel to each other and perpendicular to the strips 103.

In the example shown in FIG. 1, the device 100 comprises a support substrate 110, for example made of a semiconductor material such as silicon. The ultrasonic transducer array 101 is arranged on the upper side of the substrate 110. More particularly, in this example, a dielectric layer 112, for example a silicon oxide layer, forms an interface between the substrate 110 and the ultrasonic transducer array 101. The dielectric layer 112 extends, for example, continuously over the entire top surface of the supporting substrate 110. By way of example, layer 112 is in contact, via its underside, with the upper surface of substrate 110, over substantially the entire upper surface of substrate 110.

The lower electrode strips 103 are arranged on the upper side of the dielectric layer 112, for example in contact with the upper side of the dielectric layer 112. The strips 103 can be separated laterally from one another by dielectric strips 121, for example of silicon oxide, extending parallel to the strips 103 and having a thickness substantially identical to that of the strips 103.

Each transducer 101 has a cavity 125 formed in a rigid support layer 127, and a flexible membrane 123 suspended above the cavity 125. The layer 127 is, for example, a silicon oxide layer. Layer 127 is arranged on the upper, for example substantially flat, surface of the assembly formed by the alternating strips 103 and 121. In each transducer 101, cavity 125 faces the lower electrode E1 of the transducer.

In the example shown, each transducer 101 comprises a single cavity 125 facing its lower electrode E1. Alternatively, in each transducer 101, cavity 125 may be divided into a plurality of elementary cavities, for example arranged, in plan view, in an array in rows and columns, separated laterally from one another by side walls formed by portions of layer 127.

In the example shown, at the bottom of each cavity 125, a dielectric layer 129, for example of silicon oxide, coats the lower transducer electrode E1, so as to prevent any electrical contact between the flexible membrane 123 and the lower transducer electrode E1. Alternatively, to ensure this electrical insulation function, a dielectric layer (not shown) can coat the underside of membrane 123. In this case, layer 129 may be omitted.

In each transducer 101, the flexible membrane 123 lining the transducer cavity 125 is made, for example, of a doped or undoped semiconductor material, such as silicon.

In each transducer 101, the upper transducer electrode E2 is arranged on and in contact with the upper face of the flexible transducer membrane 123, in line with the cavity 125 and the lower transducer electrode E1. Alternatively, in the case of a semiconductor membrane, the top electrode E2 of each transducer 101 may be formed by the membrane itself, in which case layer 105 may be omitted.

By way of example, in each row Rᵢ of device 100, the flexible membranes 123 of the transducers 101 of the row form a continuous membrane strip extending along substantially the entire length of the row, separated laterally from the membrane strips of adjacent rows by a dielectric region. In each row Rᵢ, the membrane strip 123 of the row coincides, for example, when viewed from above, with strip of upper electrodes 105 of the row.

For each row Rᵢ of the array of transducers 101, the device 100 may comprise a transmitting circuit, a receiving circuit, and a controllable switch for, in a first configuration, connecting the electrodes E2 of the transducers of the row to an output terminal of the transmitting circuit of the row, and, in a second configuration, connecting the electrodes E2 of the transducers of the row to an input terminal of the receiving circuit of the row.

In addition, for each column Cⱼ of the transducer array 101, the device 100 may comprise a transmit circuit, a receive circuit, and a controllable switch for, in a first configuration, connecting the electrodes E1 of the transducers of the column to an output terminal the transmit circuit of the column, and, in a second configuration, connecting the electrodes E1 of the transducers of the column to an input terminal of the receive circuit of the column.

For the sake of simplicity, the transmit/receive circuits and switches of device 100 have not been shown in the figures. Furthermore, the embodiment of these elements have not been detailed, the embodiments described being compatible with the usual embodiments of transmit/receive circuits of row-column addressed matrix ultrasound imaging devices. As a non-limiting example, the transmit/receive circuits may be identical or similar to those described in French patent application N°19/06515 filed by the applicant on Jun. 18, 2019.

The acquisition of an ultrasound image of a body by means of a row-column-addressed matrix ultrasound imaging device, for example of the type described in relation to FIGS. 1 and 2, may comprise a phase of transmission of an ultrasound wave, followed by a phase of reception of a return ultrasound wave, reflected by the body.

For example, during the emission phase, the row electrodes of the array of transducers (corresponding to electrodes 105 in the example of FIGS. 1 and 2) are held at a fixed reference potential, e.g. ground, and a DC bias potential Vias is applied to each of the array's column electrodes (corresponding to electrodes 103 in the example of FIGS. 1 and 2). An AC excitation voltage V_{exc} is also applied to each of the array column electrodes. Thus, each transducer 101 of the array sees, between its electrodes E1 and E2, the AC excitation voltage V_{exc} superimposed on a DC polarization voltage Vbias. This causes a vibration of the transducer membrane, leading to the emission of an ultrasonic acoustic wave.

During the reception phase, the column electrodes can be maintained at the DC polarization potential V_{bias}. An AC voltage superimposed on the DC polarization voltage V_{bias} then appears between electrodes E1 and E2 of each transducer 101 under the effect of the acoustic return wave. The alternating voltages produced individually by the array's elementary transducers, also referred to as individual elementary transducer contributions, combine on the array's row and column electrodes, and resulting voltages can be read on said row and column electrodes.

An object of one embodiment is to provide a method of acquiring an ultrasound image by means of a row-column-addressed matrix ultrasound imaging device, enabling the individual contributions of the array's elementary transducers to be determined, so as to benefit both from the advantages of fully-populated devices in terms of imaging resolution, and from row-column-addressed devices in terms of electronic complexity.

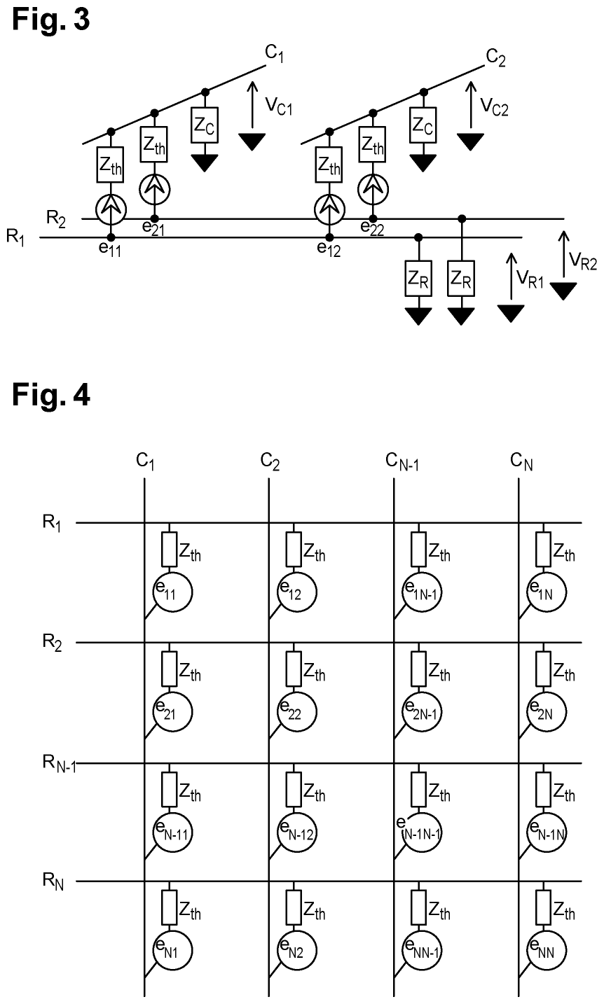

FIG. 3 is an equivalent circuit diagram of a 2-row, 2-column, row-column-addressed ultrasonic matrix imaging device, during an ultrasonic wave reception phase.

Each elementary transducer can be modeled by a voltage generator eᵢⱼ in series with an impedance Zₜₕ between a row electrode Rᵢ (corresponding to an electrode 105 in the example implementation of FIGS. 1 and 2) and a column electrode Cⱼ (corresponding to an electrode 103 in the example implementation of FIGS. 1 and 2). Each voltage value eᵢⱼ is representative of the vibration of the elementary transducer with coordinates i, j in the array under the effect of the ultrasonic wave received, and corresponds to the individual contribution of the elementary transducer to the voltages measured on the device's row and/or column electrodes. In addition, for each row of the array, a charge impedance Z_{R} between the row electrode Rᵢ and ground, and, for each column of the array, a charge impedance Z_{C} between the column electrode Cⱼ and ground, are shown. The impedances Zₜₕ of the various elementary transducers of the array are, for example, all identical or substantially identical. The load impedances Z_{R} connected to the various row electrodes Rᵢ of the array are, for example, all identical or substantially identical. The load impedances Z_{C} connected to the various column electrodes Cⱼ of the array are, for example, all identical or substantially identical. Here it is referred to V_{Ri} as the alternating voltage appearing on row Rᵢ during a phase of reception of an ultrasonic wave, and to V_{Cj} as the alternating voltage appearing on column Cⱼ during a phase of reception of an ultrasonic wave.

By applying the principle of superposition, the following system of equations can be written:

$$\{ \begin{matrix}{V}_{R 1} = {a}_{11 R 1} * {e}_{11} + {a}_{12 R 1} * {e}_{12} + {a}_{21 R 1} * {e}_{21} + {a}_{22 R 1} * {e}_{22} \\ {V}_{R 2} = {a}_{11 R 2} * {e}_{11} + {a}_{12 R 2} * {e}_{12} + {a}_{21 R 2} * {e}_{21} + {a}_{22 R 2} * {e}_{22} \\ {V}_{C 1} = {a}_{11 C 1} * {e}_{11} + {a}_{12 C 1} * {e}_{12} + {a}_{21 C 1} * {e}_{21} + {a}_{22 C 1} * {e}_{22} \\ {V}_{C 2} = {a}_{11 C 2} * {e}_{11} + {a}_{12 C 2} * {e}_{12} + {a}_{21 C 2} * {e}_{21} + {a}_{22 C 2} * {e}_{22}\end{matrix} \qquad [ Math 1 ]$$

where each coefficient a_{ijRk} is representative of the weight of the contribution of the generator eᵢⱼ to the voltage V_{Rk} Of the row Rₖ, with k an integer ranging from 1 to N, and where each coefficient a_{ijCk} is representative of the weight of the contribution of the generator eᵢⱼ to the voltage V_{Ck} of the column Cₖ.

FIG. 4 is an equivalent circuit diagram of an N-row, N-column, row-column-addressed ultrasonic matrix imaging device. The equivalent circuit diagram in FIG. 4 is similar to that in FIG. 2. For the sake of simplicity, the load impedances Z_{R} connected to the rows and the load impedances Z_{C} connected to the columns have not been shown in FIG. 4.

Using the previous notations, the above-mentioned system of equations [Math 1] can be rewritten in matrix form as follows: [A]+[e]=[V]

With:

$$[ A ] = [ \begin{matrix}{a}_{11 R 1} & {a}_{12 R 1} & … & {a}_{N ( N - 1 ) R 1} & {a}_{NNR 1} \\ {a}_{11 R 2} & {a}_{12 R 2} & … & {a}_{N ( N - 1 ) R 2} & {a}_{NNR 2} \\ … & … & … & … & … \\ {a}_{11 RN} & {a}_{12 RN} & … & {a}_{N ( N - 1 ) RN} & {a}_{NNRN} \\ {a}_{11 C 1} & {a}_{12 C 1} & … & {a}_{N ( N - 1 ) C 1} & {a}_{NNC 1} \\ … & … & … & … & … \\ {a}_{11 C ( N - 1 )} & {a}_{12 C ( N - 1 )} & … & {a}_{N ( N - 1 ) C ( N - 1 )} & {a}_{NNC ( N - 1 )} \\ {a}_{11 CN} & {a}_{12 CN} & … & {a}_{N ( N - 1 ) CN} & {a}_{NNCN}\end{matrix} ] \qquad [ Math 2 ]$$

And:

$$[ e ] = [ \begin{matrix}{e}_{11} \\ {e}_{12} \\ ⋮ \\ {e}_{NN - 1} \\ {e}_{NN}\end{matrix} ] \qquad [ Math 3 ]$$

And:

$$[ V ] = [ \begin{matrix}{V}_{R 1} \\ ⋮ \\ {V}_{RN} \\ {V}_{C 1} \\ ⋮ \\ {V}_{CN}\end{matrix} ] \qquad [ Math 4 ]$$

The 2N*(N*N) coefficients of the matrix [A] can be determined beforehand during a device characterization or simulation phase, and stored in a memory of an electronic processing device. The 2N*(N*N) coefficients of the matrix [A] are, for example, non-zero and non-unitary (in absolute value).

The 2N voltages of the vector [V] can be read on the row and column electrodes of the array.

This gives a system with 2N equations and N*N unknowns (the N*N voltage values eᵢⱼ).

As it stands, this system cannot be solved, as the number of independent equations is less than the number of unknowns.

According to one aspect of one embodiment, as will be explained in greater detail below, it is planned to increase the number of discriminating equations in the system, by carrying out several successive firings of the same ultrasound wave (i.e. a beam of the same characteristics) in the direction of the body to be analyzed, and by modifying the sign of at least one generator eᵢⱼ each time, during the return wave reception phase.

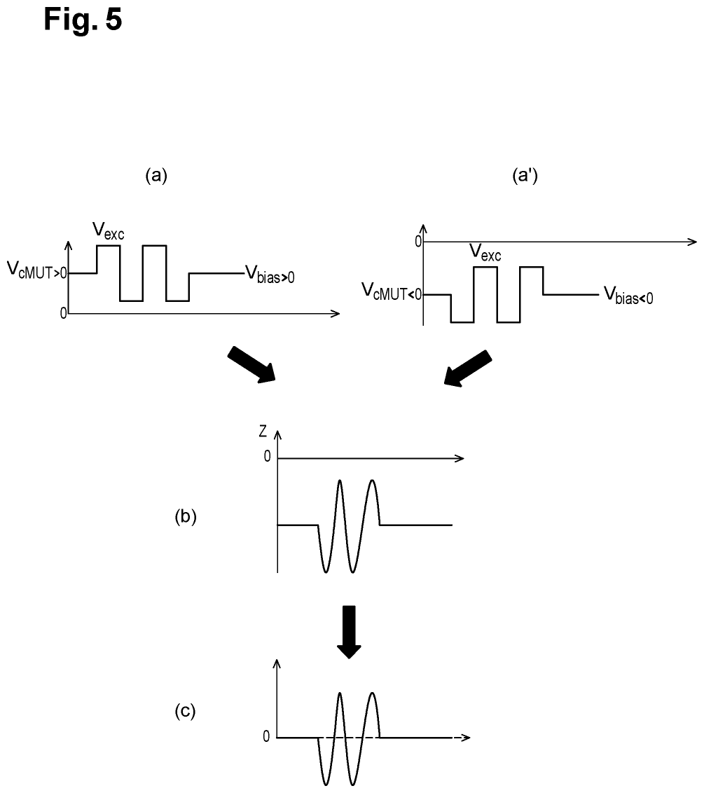

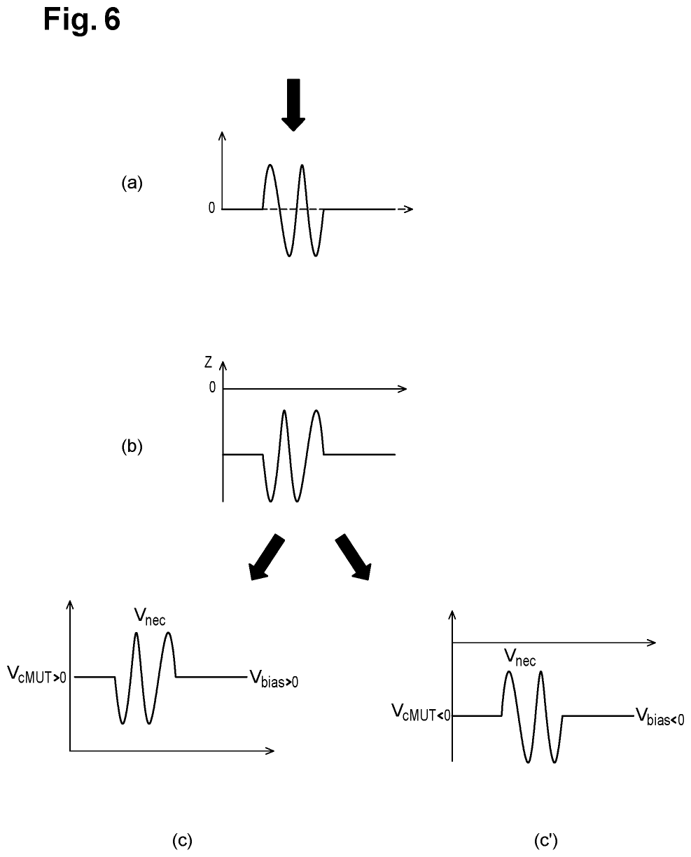

In a preferred embodiment, for each shot, the sign of the bias voltage applied to at least one of the array column electrodes during the return wave reception phase is modified, so as to invert the sign of all the generators eᵢⱼ in said at least one column. This takes advantage of the voltage-symmetrical behavior of CMUT transducers, which will be recalled below in relation to FIGS. 5 and 6. More generally, the preferred embodiment described below applies to any type of transducer with symmetrical behavior, particularly in reception, such PMUT as transducers (Piezoelectric Micromachined Ultrasonic Transducers). By symmetrical behavior in reception, it is meant that the sign of the AC voltage produced by the transducer during a reception phase of an ultrasonic wave is reversed when the sign of the DC bias voltage applied to the transducer during this same reception phase is reversed.

FIG. 5 schematically illustrates the behavior of an example of a CMUT transducer in emission.

FIG. 5 shows a diagram (a) representing an example of the voltage V_{cMUT} that can be applied between the transducer electrodes during a transmission phase. In this example, the voltage V_{cMUT} is a positive voltage corresponding to the superposition (or sum) of a positive DC bias voltage V_{bias} and an AC excitation voltage V_{exc}. In this example, the AC excitation voltage is a square-wave voltage comprising successively a high state, a low state, a high state and a low state.

Applying voltage V_{cMUT} across the transducer leads to a vibratory displacement of the transducer diaphragm along a z-axis orthogonal to the diaphragm, illustrated by diagram (b) in FIG. 5. In this diagram, position 0 corresponds to the mechanical equilibrium position of the membrane, in the absence of any electrical polarization.

This vibratory displacement of the membrane leads to the emission of an acoustic wave, illustrated by diagram (c) in FIG. 5.

FIG. 5 also shows a diagram (a′) representing another example of a voltage V_{cMUT} that can be applied between the transducer electrodes during a transmission phase. In this example, the voltage V_{cMUT} is a negative voltage corresponding to the opposite of the voltage V_{cMUT} in diagram (a). Thus, in this example, the voltage V_{cMUT} corresponds to the superposition of a negative DC bias voltage V_{bias} and an AC excitation voltage V_{exc}. The DC bias voltage V_{bias} in diagram (a′) corresponds to the opposite of the DC bias voltage V_{bias} in diagram (a), and the AC excitation voltage V_{exc} in diagram (a′) corresponds to the opposite of the AC excitation voltage V_{exc} in diagram (a). Thus, in this example, the AC excitation voltage is a square-wave voltage comprising successively a low state, a high state, a low state, and a high state.

As shown in FIG. 5, applying the voltage V_{cMUT} in diagram (a′) to the transducer terminals leads to a vibratory displacement identical to that obtained with the application of the voltage V_{cMUT} in diagram (a), and consequently to the emission of an acoustic wave identical to that obtained with the application of the voltage V_{cMUT} in diagram (a). Thus, reversing the sign of the voltage applied to the transducer does not alter the transducer's emission behaviour.

FIG. 6 schematically illustrates the behavior of an example of a CMUT transducer during reception.

FIG. 6 shows a diagram (a) representing an example of an acoustic wave received by the CMUT transducer.

FIG. 6 also includes a diagram (b) illustrating the vibratory displacement of the transducer diaphragm under the effect of the received acoustic wave, when the transducer is biased at a DC voltage V_{bias}. Note that this displacement is independent of the sign, positive or negative, of the voltage V_{bias}.

FIG. 6 also shows a diagram (c) representing the voltage V_{cMUT} across the transducer during a reception phase. In this example, the DC bias voltage V_{bias} applied across the transducer is a positive voltage. The voltage V_{cMUT} is then a positive voltage corresponding to the superposition or sum of the voltage V_{bias} and an AC voltage V_{rec} generated by the vibration of the diaphragm.

FIG. 6 also shows a diagram (c′) representing the voltage V_{cMUT} across the transducer during a reception phase. In this example, the DC bias voltage V_{bias} applied across the transducer is a negative voltage. More specifically, in this example, the DC bias voltage V_{bias} applied across the transducer is the opposite of that applied in the example in diagram (c). The voltage V_{cMUT} is then a negative voltage corresponding to the superposition of the voltage V_{bias} and an AC voltage V_{rec} generated by the vibration of the diaphragm. As shown in FIG. 6, the voltage V_{rec} in diagram (c′) is the opposite of the voltage V_{rec} in diagram (c). Thus, reversing the sign of the received DC bias voltage V_{bias} leads to a reversal of the sign of the AC voltage V_{rec} generated across the transducer under the effect of a received acoustic wave.

Using the previous notations and considering an elementary transducer of a row-column-addressed matrix ultrasound imaging device, the alternating voltage V_{rec} appearing across the transducer under the effect of a received acoustic wave corresponds to the contribution eᵢⱼ of the transducer to the voltage signals read on the device's row Rᵢ or column Cⱼ electrodes.

Thus, by inverting the DC bias voltage V_{bias} of a receiving column, the sign of the eᵢⱼ contributions of the column's transducers is inverted. As will be described in greater detail below, this makes it possible to obtain additional discriminating equations that allow to determine the individual contributions of the array's elementary transducers.

It should be noted that, insofar as the transducer response remains linear, the same weighting coefficient can be applied to the DC bias voltages V_{bias} and/or to the AC excitation voltages V_{exc}, and this coefficient can be modified between two successive shots or between two successive reception phases of the process. A correction can be applied when reconstructing the individual transducer contributions to take account of this weighting.

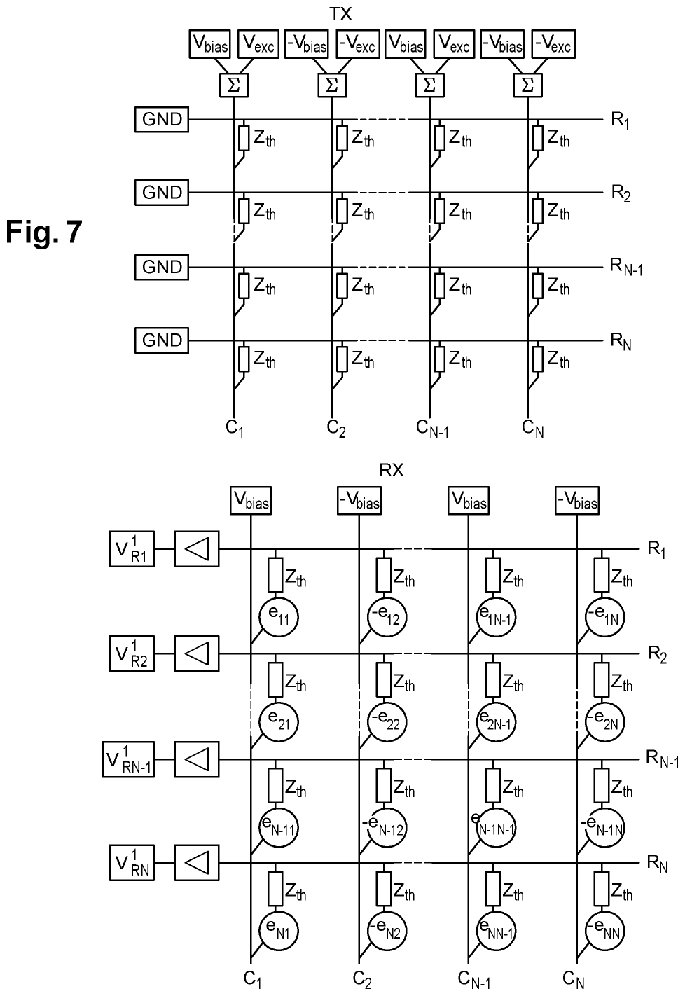

FIG. 7 schematically illustrates a TX transmission step and an RX reception step in a process for acquiring an image of a body using a row-column-addressed matrix ultrasound imaging device of dimensions N×N.

In this example, during the TX emission phase, a DC bias voltage V_{bias} and an AC excitation voltage V_{exc} are applied to the electrodes of the odd-numbered columns Cⱼ, and an opposing DC bias voltage-V_{bias} and an opposing AC excitation voltage-V_{exc} are applied to the electrodes of the even-numbered columns Cⱼ. In FIG. 7, each elementary transducer is represented by an impedance Zₜₕ during the TX transmission phase. During the RX receive phase, the DC bias voltages V_{bias} and −V_{bias} applied respectively to the electrodes of the odd-numbered column Cⱼ and to the electrodes of the even-numbered column Cⱼ remain unchanged.

As explained above in relation to FIG. 5, reversing the sign of the voltages V_{bias} and V_{exc} on even-numbered columns has no impact on the acoustic wave emitted by the column transducers. In other words, the ultrasonic wave emitted is the same as if the signs of the voltages Vias and V_{exc} were the same on all columns.

At the receiving end, on the other hand, reversing the sign of the DC bias voltage in even-numbered columns reverses the signs of the eᵢⱼ contributions of the elementary transducers in said columns, as explained above in relation to FIG. 6.

By firing the same ultrasonic wave several times in succession, each time modifying the sign of the polarization voltages applied to certain columns in the reception phase, and by making linear combinations of the voltages measured on the row Rᵢ electrodes, it is possible to determine the individual contributions eᵢⱼ of each of the elementary transducers in the array.

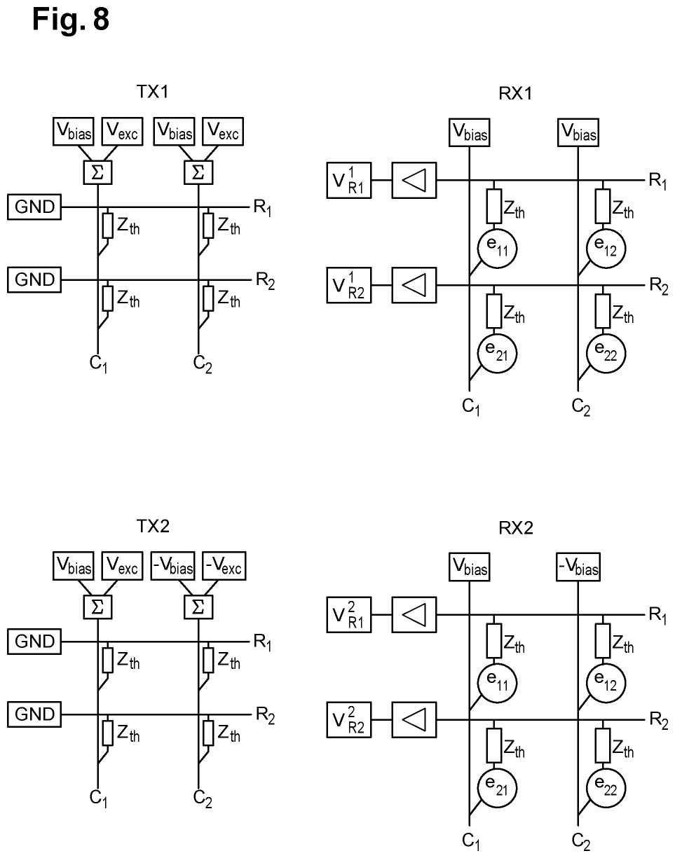

FIG. 8 schematically illustrates an example of a method for acquiring an image of a body using a 2×2 row-column-addressed matrix ultrasound imaging device.

The procedure shown in FIG. 8 comprises two successive shots of the same ultrasonic wave in the direction of the body to be analyzed.

More particularly, the method comprises a first step of transmitting TX1 an ultrasonic wave (first shot), followed by a first step of receiving RX1 a return wave reflected by the body to be analyzed, followed by a second step of transmitting TX2 an ultrasonic wave (second shot) identical to that transmitted in step TX1, followed by a second step of receiving RX2 a return wave reflected by the body to be analyzed.

During the TX1 emission step, the column electrodes C₁ and C₂ are polarized at the same DC voltage V_{bias}, and receive the same AC excitation voltage V_{exc} superimposed on the voltage V_{bias}.

During the RX1 reception phase, the column electrodes C₁ and C₂ remain polarized at voltage V_{bias}, and alternating voltages V_{R1}¹ and V_{R2}¹ are read from row electrodes R₁ and R₂ respectively.

The following system of equations can then be written:

$$\{ \begin{matrix}{V}_{R 1}^{1} = {a}_{11 R 1} * {e}_{11} + {a}_{12 R 1} * {e}_{12} + {a}_{21 R 1} * {e}_{21} + {a}_{22 R 1} * {e}_{22} \\ {V}_{R 2}^{1} = {a}_{11 R 2} * {e}_{11} + {a}_{12 R 2} * {e}_{12} + {a}_{21 R 2} * {e}_{21} + {a}_{22 R 2} * {e}_{22}\end{matrix} \qquad [ Math 5 ]$$

During the TX2 emission step, the column electrodes C₁ and C₂ are polarized at the voltage V_{bias} and the voltage −V_{bias} respectively, and receive the excitation AC voltage V_{exc} and the opposite excitation AC voltage −V_{exc} respectively.

During the RX2 reception phase, column electrodes C₁ and C₂ remain polarized at voltage V_{bias} and voltage-V_{bias} respectively, and alternating voltages V_{R1}² and V_{R2}² are read from row electrodes R₁ and R₂ respectively.

The following system of equations can then be written:

$$\{ \begin{matrix}{V}_{R 1}^{2} = {a}_{11 R 1} * {e}_{11} - {a}_{12 R 1} * {e}_{12} + {a}_{21 R 1} * {e}_{21} - {a}_{22 R 1} * {e}_{22} \\ {V}_{R 2}^{2} = {a}_{11 R 2} * {e}_{11} - {a}_{12 R 2} * {e}_{12} + {a}_{21 R 2} * {e}_{21} - {a}_{22 R 2} * {e}_{22}\end{matrix} \qquad [ Math 6 ]$$

Summing the two systems of equations [Math 5] and [Math 6] above, a system with two equations and two unknowns is obtained, that can be rewritten in matrix form as follows: [A]*[e]=[V], with:

$$[ A ] = [ \begin{matrix}{a}_{11 R 1} & {a}_{21 R 1} \\ {a}_{11 R 2} & {a}_{21 R 2}\end{matrix} ] \qquad [ Math 7 ]$$

And:

$$[ e ] = [ \begin{matrix}{e}_{11} \\ {e}_{21}\end{matrix} ] \qquad [ Math 8 ]$$

And:

$$[ V ] = [ \begin{matrix}\frac{{V}_{R 1}^{1} + {V}_{R 1}^{2}}{2} \\ \frac{{V}_{R 2}^{1} + {V}_{R 2}^{2}}{2}\end{matrix} ] \qquad [ Math 9 ]$$

As the matrix A is invertible, the system can be solved, allowing to determine the respective contributions e₁₁ and e₂₁ of the elementary transducers of rank i=1 and rank i=2 of the column of rank j=1.

Similarly, by subtracting the two systems of equations [Math 5] and [Math 6] above, a system with two equations and two unknowns is obtained, that can be rewritten in matrix form as follows: [A]*[e]=[V], with:

$$[ A ] = [ \begin{matrix}{a}_{12 R 1} & {a}_{22 R 1} \\ {a}_{12 R 2} & {a}_{22 R 2}\end{matrix} ] \qquad [ Math 10 ]$$

And:

$$[ e ] = [ \begin{matrix}{e}_{12} \\ {e}_{22}\end{matrix} ] \qquad [ Math 11 ]$$

And:

$$[ V ] = [ \begin{matrix}\frac{{V}_{R 1}^{1} + {V}_{R 1}^{2}}{2} \\ \frac{{V}_{R 2}^{1} + {V}_{R 2}^{2}}{2}\end{matrix} ] \qquad [ Math 12 ]$$

Again, since the matrix A is invertible, the system can be solved, allowing to determine the respective contributions e₁₂ and e₂₂ of the elementary transducers of rank i=1 and rank i=2 of the column of rank j=2.

Thus, by firing the same ultrasonic wave twice, reversing the sign of the polarization voltage Vias of one of the columns between the two corresponding reception phases, and making linear combinations of the AC voltages measured at reception on the electrodes, the individual contributions eᵢⱼ of each of the four elementary transducers in the array can be determined.

It should be noted that, as explained above in relation to FIG. 5, reversing the sign of polarization voltage V_{bias} and excitation the voltage V_{exc} during transmission phase has no effect on the transmitted ultrasound wave. For example, it could be envisaged to carry out both shots with the same polarization and excitation voltages, and to modify the sign of the polarization voltage of one of the columns only during the RX2 reception phase. In practice, however, it can be tricky to reverse the sign of a column's polarization voltage between the transmit and receive phases of the same ultrasound wave. It is therefore preferable to modify the sign of the polarization voltage of column electrode C₂ as early as the TX2 transmission phase.

This mode of operation can be generalized regardless of the number N of rows and columns in the array.

For an array of dimensions N×N, at least N successive shots TX1, . . . . TXN, each time changing the sign of the bias voltage applied to at least one of the array's column electrodes during the respective subsequent reception phase RX1, . . . . RXN.

Preferably, the signs of the polarization voltages applied respectively to the N column electrodes C₁, . . . . C_{N} during the N reception phases RX1, . . . . RXN are encoded by the vectors of an orthogonal matrix, such as a Hadamard matrix. Using N linear combinations of the voltage measurements made on the row Rᵢ electrodes of the array, N subsystems of matrix equations of the type [A]*[e]=[V] are obtained, with, for each subsystem, an invertible matrix A of dimensions N*N. This allows to trace the individual contributions eᵢⱼ of the device's N*N elementary transducers.

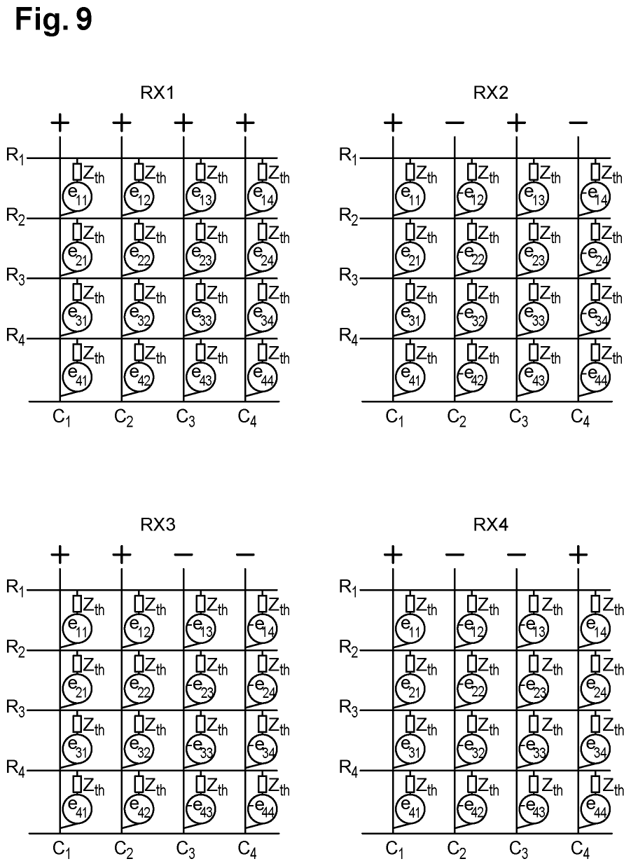

FIG. 9 schematically illustrates, by way of an illustrative example, a method for acquiring an image of a body using a 4×4 row-column-addressed matrix ultrasound imaging device. The person skilled in the art will be able to adapt the described procedure whatever the number N of rows and columns of the device.

In particular, FIG. 9 shows the signs of the polarization voltages applied to the column electrodes Cⱼ of the array during the four successive reception phases RX1, RX2, RX3 and RX4 of the process. On this figure, a + sign is shown at the top of the column when the polarization voltage applied to the column is equal to V_{bias}, and a − sign is shown at the top of the column when the polarization voltage applied to the column is equal to V−_{bias}.

In the RX1 reception phase following the first shot, the column electrodes C₁, C₂, C₃ and C₄ are all positively polarized (++++). During the RX2 reception phase following the second shot, the column electrodes C₁, C₂, C₃ and C₄ are positively, negatively, positively and negatively polarized respectively (+−+−). During the RX3 reception phase following the third shot, the column electrodes C₁, C₂, C₃ and C₄ are polarized positively, positively, negatively and negatively (++−−) respectively. In the RX4 reception phase following the fourth shot, the column electrodes C₁, C₂, C₃ and C₄ are polarized positively, negatively, negatively and positively (+−−+) respectively.

For each of the reception phases RX1, RX2, RX3 and RX4, a system of equations of the same type as the systems [Math 5] and [Math 6] described above can be written, each time with N equations per system and N*N terms a_{ijRi}*eᵢⱼ per equation.

The corresponding N=4 systems of equations are hereafter referred to as T1, T2, T3 and T4.

By performing N=4 linear combinations of systems T1, T2, T3 and T4, N=4 subsystems of matrix equations of type [A]*[e]=[V] are obtained, with, for each subsystem, an invertible matrix A of dimensions N*N=16. This allows to determine the individual contributions eᵢⱼ of the device's N*N=16 elementary transducers.

The N linear combinations of systems T1, T2, T3 and T4, for example, are coded by the same vectors as those used to code the signs of the bias voltages applied to the array columns during the N RXi reception phase.

By summing T1+T2+T3+T4, a first subsystem of type [A]*[e]=[V] is obtained

With:

$$[ A ] = [ \begin{matrix}{a}_{11 R 1} & {a}_{21 R 1} & {a}_{31 R 1} & {a}_{41 R 1} \\ {a}_{11 R 2} & {a}_{21 R 2} & {a}_{31 R 2} & {a}_{41 R 2} \\ {a}_{11 R 3} & {a}_{21 R 3} & {a}_{31 R 3} & {a}_{41 R 3} \\ {a}_{11 R 4} & {a}_{21 R 4} & {a}_{31 R 4} & {a}_{41 R 4}\end{matrix} ] \qquad [ Math 16 ]$$

And:

$$[ e ] = [ \begin{matrix}{e}_{11} \\ {e}_{21} \\ {e}_{31} \\ {e}_{41}\end{matrix} ] \qquad [ Math 17 ]$$

And:

$$[ V ] = [ \begin{matrix}\frac{{V}_{R 1}^{1} + {V}_{R 1}^{2} + {V}_{R 1}^{3} + {V}_{R 1}^{4}}{4} \\ \frac{{V}_{R 2}^{1} + {V}_{R 2}^{2} + {V}_{R 2}^{3} + {V}_{R 2}^{4}}{4} \\ \frac{{V}_{R 3}^{1} + {V}_{R 3}^{2} + {V}_{R 3}^{3} + {V}_{R 3}^{4}}{4} \\ \frac{{V}_{R 4}^{1} + {V}_{R 4}^{2} + {V}_{R 4}^{3} + {V}_{R 4}^{4}}{4}\end{matrix} ] \qquad [ Math 18 ]$$

Since the matrix A is invertible, the system can be solved, allowing to determine the respective contributions e₁₁ of the elementary transducers in the column of rank j=1.

By summing T1−T2+T3−T4, the respective contributions e₁₂ of the elementary transducers in the column of rank j=2 can similarly be determined.

By summing T1+T2−T3−T4, the respective contributions e₁₃ of the elementary transducers in the column of rank j=3 can similarly be determined.

By summing T1−T2−T3+T4, the respective contributions e₁₄ of the elementary transducers in the column of rank j=4 can similarly be determined.

Thus, by performing N*N binary combinations of the N*N voltages measured on the N row Rᵢ electrodes at the end of each of the device's N shots, and multiplying the resulting vector of dimensions N*N by an array of N*(N*N) predetermined coefficients a_{ijRi}, the respective contributions eᵢⱼ of the device's N*N elementary transducers are directly obtained.

An advantage of the proposed acquisition process is that it allows to benefit from both the advantages of fully populated devices in terms of imaging resolution, and of row-column addressed devices in terms of electronic complexity.

Various embodiments and variants have been described. The person skilled in the art will understand that certain features of these various embodiments and variants could be combined, and other variants will become apparent to the person skilled in the art. In particular, the embodiments described are not limited to the particular example of the elementary transducer array embodiment described in connection with FIGS. 1 and 2.

Furthermore, although in the examples described above, the DC bias voltages V_{bias} and −V_{bias} applied to the various Cⱼ column electrodes of the device are all of the same amplitude in absolute value, the embodiments described are not limited to this particular case. Alternatively, the amplitude levels of the DC bias voltages applied to the various Cⱼ column electrodes, on transmit and/or receive, can be differentiated. Similarly, the alternating excitation voltages V_{exc} applied to the transmitting Cⱼ column electrodes can be differentiated by column.

Furthermore, the modes of implementation described are not limited to the examples detailed above, in which the inversion of the sign of the contribution eᵢⱼ of the elementary transducers of a column is obtained by inverting the sign of the DC bias voltage Vias applied to this column. More generally, any other means of reversing the sign of the eᵢⱼ contribution of one or more elementary transducers between two successive shots of the same ultrasonic wave can be provided. By way of example, each elementary position transducer (i,j) in the array is associated with a system of switches, for example electromechanical switches, enabling the direction of connection of the transducer electrodes to be reversed between the row Rᵢ and column Cⱼ electrodes of the array. In other words, in a first configuration of the switch system, the transducer has a first electrode connected to electrode Rᵢ and a second electrode connected to electrode Cⱼ, and, in a second configuration of the switch system, the transducer has its first electrode connected to electrode C; and its second electrode connected to electrode Rᵢ. Thus, by changing, between two successive shots of the same ultrasonic wave, the configuration of the switch system associated with an elementary position transducer (i, j), the sign of the eᵢⱼ contribution of this transducer is reversed. This makes it possible to increase the number of discriminating equations in the system and thus to determine the individual contributions eᵢⱼ of all the elementary transducers in the array. In this embodiment, the switch systems associated with the individual transducers can be controlled individually, transducer by transducer, or simultaneously by column. Note that this design is compatible with any type of ultrasonic transducer, including transducers that do not exhibit symmetrical voltage behavior. In particular, it is not limited to CMUT and PMUT transducers.

Furthermore, although examples of implementation based on voltage measurements on the device electrodes have been described above, the modes of implementation described are not limited to this particular case. Alternatively, the described embodiments can be adapted to determine the individual contributions of the elementary transducers from measurements of another variable electrical quantity, e.g. current, charges or impedance, on the device electrodes.

Furthermore, although the above detailed examples of the proposed acquisition process have been given for square transducer arrays of N rows by N columns, the embodiments described are not limited to this particular case. Reading the present description, the person skilled in the art will know how to adapt the proposed process to matrix devices of M rows by N columns, with M different from N.

Furthermore, in the examples described above, each time the ultrasonic wave is fired, the wave is generated by the same matrix device as that used to receive the return wave. However, the embodiments described are not limited to this particular case. Alternatively, the array of transducers is used solely as a receiver device, to receive the ultrasonic wave returned by the body to be analyzed, and a separate transmitter device (not detailed) is used to transmit the ultrasonic wave towards the body to be analyzed. The transmitting device and the receiving device are then synchronized to implement the alternating N TX transmission phases and N RX reception phases.

In addition, the practical implementation of the described embodiments and variants is within the reach of the person skilled in the art on the basis of the functional indications given above. In particular, the design of the electronic circuits controlling the transmitter and receiver devices to implement the proposed process has not been detailed, the design of these circuits being within the reach of the person skilled in the art on reading the present description. Furthermore, the design of the electronic processing devices enabling the individual contributions of the elementary transducers to be determined from the quantities measured on the electrodes of the device have not been detailed, the design of such devices being within the reach of the person skilled in the art on the basis of the teachings of the present description.

It should also be noted that in the examples described above, row and column designations are arbitrary and can of course be reversed.

1. A method of acquiring an image of a body by means of a row-column addressed matrix ultrasonic imaging device, the device comprising an array of elementary ultrasonic transducers connected in rows and columns by respectively row electrodes and column electrodes, the method comprising:
performing N successive shots of the same ultrasonic wave towards said body, where N is an integer greater than or equal to 2;
after each shot, implementing a reception phase, by means of said device, of a return ultrasonic wave reflected by said body,
in which, during each of the reception phases, a variable electrical quantity representative of the received wave is read at each row electrode of the device,
and in which, between any two of the N reception phases, the sign of the individual contribution of at least one elementary ultrasonic transducer of the array is modified,
the method further comprising a step of calculating, by means of an electronic processing device, by linear combinations of the electrical variable quantities read on the row electrodes of the device during the N reception phases, of an individual contribution of each of the elementary transducers of the array.

2. The method of claim 1, wherein the calculation of the individual contributions of the elementary transducers of the array comprises a multiplication of the electrical variable quantities read on the row electrodes of the device during the N reception phases by coefficients of a matrix, previously determined during a characterization or simulation phase and stored in a memory of the electronic processing device.

3. The method of claim 1, wherein, during each of the N receiving phases, each column electrode of the array is maintained at a DC bias voltage, and wherein, between any two of the N receiving phases, the sign of the DC bias voltage applied to at least one of the device's column electrodes is changed.

4. The method of claim 3, wherein the signs of the polarization voltages applied respectively to the column electrodes of the device during the N reception phases are coded by the vectors of an orthogonal matrix, for example a Hadamard matrix.

5. The method of claim 3, wherein the N successive shots are performed by means of said row-column-addressed matrix ultrasonic imaging device, and wherein, during each of the N shots, each column electrode of the array is held at a DC bias voltage, and an AC excitation voltage superimposed on the DC bias voltage is applied to said column electrode, and wherein, during each shot, the signs of the DC bias voltages applied respectively to the column electrodes of the array are the same as the signs of the DC bias voltages applied respectively to the column electrodes in the subsequent receiving phase.

6. The method of claim 1, wherein, between any two of the N receiving phases, the electrical connection of at least one elementary transducer between the row and column electrodes is reversed by means of a system of switches, so as to modify the sign of the individual contribution of said at least one elementary ultrasonic transducer of the array.

7. The method of claim 1, wherein the ultrasonic transducers are Capacitive Micromachined Ultrasonic Transducers or Piezoelectric Micromachined Ultrasonic Transducers.

8. The method of claim 1, wherein said array comprises N rows and N columns of elementary ultrasonic transducers.

9. The method of claim 1, wherein the electrical variable quantity read on each row electrode of the device is a voltage value.

10. A row-column addressed matrix ultrasonic imaging device, the device comprising a array of elementary ultrasonic transducers connected in rows and columns by respective row electrodes and column electrodes, and a control circuit configured to implement a method according to claim 1.

11. The device of claim 10, wherein the ultrasonic transducers are Capacitive Micromachined Ultrasonic Transducers or Piezoelectric Micromachined Ultrasonic Transducers.
